(19) United States
(12) Patent Application Publication
(10) Pub. No.: US 2007/0168963 A1
(43) Pub. Date: Jul. 19, 2007

(54) Method and system for customization of software application

(76) Inventor: Stewart A. Pisecco, Houston, TX (US)

Correspondence Address: FULBRIGHT & JAWORSKI L.L.P., 80 SOUTH EIGHTH STREET, SUITE 2100, MINNEAPOLIS, MN, 55402, US

(21) Appl. No.: 11/526,361

(22) Filed: Sep. 25, 2006

Related U.S. Application Data
(60) Provisional application No. 60/720,146, filed on Sep. 23, 2005.

(51) Int. Cl. G06F 9/44

(52) U.S. Cl. 717/120

(57) ABSTRACT

A method and system for assisting in the customization of a management program coordinating applicable laws and regulations, procedural rules, and/or otherwise meeting management requirements, such as institutionally-provided and/or legally mandated requirements for individualized instruction, behavioral intervention or rehabilitation, or social work or judicial intervention and/or tracking.

### RELATED APPLICATION

This application claims priority from U.S. Provisional Application No. 60/720,146 filed on Sep. 23, 2005, and hereby incorporated by reference in its entirety.

### FIELD OF THE INVENTION

The present invention relates to a method and system for providing efficient customization of a software platform, such as software utilized to automate behavioral management systems and behavioral intervention programs within a school district. More particularly, the present invention relates to a method and system to customize a software solution that is capable of providing specific instruction and support, for regular and special education teachers, during the process of development and implementation of the district's behavioral management system and individual behavioral plans for students who exhibit disruptive behavior.

### BACKGROUND OF THE INVENTION

There is an unmet need for methods and systems for tracking student behavioral information, supporting compliance with regulatory and other requirements, expertly assisting with completing forms, supporting teacher implementation of school districts' behavioral system, allowing for administrative oversight of student behavioral progress, developing code and code documentation therefore, and otherwise providing assistance in meeting requirements for the complex and sophisticated management schemes that institutions need to use in order to effectively and efficiently manage mandated individualized instructional paths, disciplinary/rehabilitative paths, or social intervention paths.

There remains an unmet need for a software based method and system for tracking and supporting compliance with a management scheme around events, outcomes, timelines, and associated paperwork, including assisting with completion of forms for implementation of a school district's behavioral management system and individualized behavioral plan for students who exhibit disruptive behaviors. At the teacher or staff level, such a database structure and forms assistant needs to support staff at any point in time in knowing explicitly what they need to do, in determining when do they need to do it by, and assisting them with timely completing any forms relating thereto. At the administrator level, such a database and forms structure needs to let administrators manage to district standards for performance, allowing transparent accountability of district wide performance, regional performance, building or site performance, and even down to the individual provider performance.

### BRIEF SUMMARY OF THE INVENTION

The present invention provides a method and system for using software wizards for assisting in the customization of a management program for assisting with applicable laws and regulations, procedural rules, and/or otherwise meeting management requirements, such as institutionally-provided and/or legally mandated requirements for individualized instruction, behavioral intervention or rehabilitation, or social work or judicial intervention and/or tracking.

The term “wizard” is often utilized in the computer programming field to refer to a utility or program module that receives input from a user and then uses the input to generate a customized response. Often, a wizard leads a user through a series of steps to generate the input to enable the wizard to perform a particular task.

In an embodiment of the present invention, a wizard assists users with developing code or modules in an automated fashion for use with the database structure and platform, such as the DAILYREVIEW program, from Psychological Software Solutions, Inc. of Houston, Tex.

The foregoing has outlined rather broadly the features and technical advantages of the present invention in order that the detailed description of the invention that follows may be better understood. Additional features and advantages of the invention will be described hereinafter which form the subject of the claims of the invention. It should be appreciated by those skilled in the art that the conception and specific embodiment disclosed may be readily utilized as a basis for modifying or designing other structures for carrying out the same purposes of the present invention. It should also be realized by those skilled in the art that such equivalent constructions do not depart from the spirit and scope of the invention as set forth in the appended claims. The novel features which are believed to be characteristic of the invention, both as to its organization and method of operation, together with further objects and advantages will be better understood from the following description when considered in connection with the accompanying figures. It is to be expressly understood, however, that each of the figures is provided for the purpose of illustration and description only and is not intended as a definition of the limits of the present invention.

### BRIEF DESCRIPTION OF THE DRAWINGS

For a more complete understanding of the present invention, reference is now made to the following descriptions taken in conjunction with the accompanying drawing, in which:

FIG. 1 is a depiction of a distributed data processing system in which the present invention may be implemented.

FIGS. 2-25 depict exemplary user interfaces for allowing a user to customize a behavioral management system.

### DETAILED DESCRIPTION OF THE INVENTION

As described above, the present invention provides a software enabled wizard. The software wizard may be utilized in computer programs and/or as part of an internet, intranet and/or extranet site. The wizard is particularly advantageous as web enabled wizards for use in a corporate intranet, extranet, or internet setting.

Specific possible embodiments of the present invention are set forth below and include, but are not limited to, wizards relating to one or more of the following: behavioral management systems, individualized behavioral plans and behavioral intervention programs.

The wizard of the present invention may be implemented utilizing software coding techniques and processes known to those of ordinary skill in the art. In general terms, a wizard of the present invention may comprise a series of questions, steps or menus to receive input from a user. The invention includes a computer-readable medium, having computer-readable instructions for generating and analyzing the input and implementing the wizard. In general, the input may be compared to database fields including relevant criteria for the wizard. A formula or other approach may be utilized to assign proportional weight to one input criterion over another input criterion.

One embodiment of the present invention provides a method and system for rapidly tailoring or customizing compliance requirements and/or definitions for an associated behavioral management system and/or behavioral intervention program. An embodiment of the present invention provides a structure and platform for rapidly configuring/customizing the database structure to mirror the school district's or county's or state's process surrounding rules, timelines, goals and associated outcomes. This approach cuts time and expense needed by a district to achieve compliance.

An embodiment of the present invention may also facilitate customization of database structures or other repository to accommodate transparent accountability so that, among other things, the management entity can view data entity wide, or drill down to regional views of data, or to site views, or to individual provider views, in order to evaluate compliance with district management standards.

An embodiment of the present invention also allows modification of existing management software of behavior intervention programs. The user interface for customization of software, in one embodiment of the present invention, involves a graphical user interface (GUI) to be used by those customizing the program. Thus, for example, the user interface for customizing modules may includes a number of popup or pulldown menus, or other selectable options, that are provided in a template of a forms GUI.

In an embodiment of the present invention, the forms are presented via an interactive and automated viewer that allows the user to view the forms identically or very similarly to their printed format. Among other advantages, this approach greatly eases user orientation to the present invention from non-automated form processing.

In an embodiment of the present invention, data, including preloaded data and data that is stored from user and/or other input, may be accessible via a network, such as the Internet, using a client terminal, such as a personal computer (PC) coupled to the network.

In an embodiment of the present invention, prior to access of data and use of forms, the user must log into the system (e.g., provide a recognized user name and one or more passwords) or otherwise meet security requirements. The user then selects record identifier information either solely within the system to create forms or via links with other systems relating to other requirements applicable to the entities and/or organization. In addition, the user may initiate a new record. The user then selects a record (or begins work on the new record), for which, for example, new input or revision is to be made.

As part of the input or revision, the user typically selects a program to be modified. Appropriate forms for the selected activity are automatically determined and presented to the user, along with status indication for the various items. For example, a number of forms may be required in conjunction with providing particular services for the district.

Embodiments of the present invention may include features or links to other systems for assisting the user with form selection or creation. Data for use in the system is, for example, obtained by a user via a terminal, such as a personal computer (PC), minicomputer, mainframe computer, microcomputer, telephonic device, or wireless device, such as a hand-held wireless device coupled to a server, such as a PC, minicomputer, mainframe computer, microcomputer, or other device having a processor and a repository for data or connection to a repository for data, via a network, such as the Internet or an intranet. In one embodiment, data is collected with a forms based system that displays views of forms presented via an interactive and automated viewer that allows the user to view the forms identically or very similarly to their printed format. A user accesses the GUI, including, for example, logging in or otherwise passing a security check

In one embodiment, the present invention is directed to a method of customizing a software program, such as the DAILYREVIEW web-based program that guides teachers and/or parents through the process of developing and implementing a specific type of classroom based behavioral intervention for student's who are hyperactive, impulsive, inattentive, defiant, and/or experiencing certain types of academic problems. In addition to serving as a teacher's personal behavioral consultant, the DAILYREVIEW program generates required paperwork, facilitates easy collection of necessary information, automatically analyzes student data, continually monitors students' progress, and troubleshoots existing behavioral plans. The DAILYREVIEW program is a product of Psychological Software Solutions, Inc., of Houston, Tex.

The Daily Review program can be used to benefit the student as the program guides teachers through the process of developing and implementing a classroom based behavioral intervention that has been consistently identified as an effective form of treatment for disruptive student behavior. Simply stated, students who are less disruptive are more likely to benefit from academic instruction.

The DAILYREVIEW program makes it easy for teachers to work together and consistently implement an intervention across multiple classroom settings. The DAILYREVIEW program gives teachers the ability to access, review, and re-activate previously developed student behavioral plans with minimal work. Less stressed teachers are more patient and effective teachers. The DAILYREVIEW program helps school personnel develop an intervention, which emphasizes student responsibility. The DAILYREVIEW program leads to the development of an intervention that helps students make the connection between their behavior and the consequences of their actions. The program makes behaving well a desirable and obtainable goal for all students.

The DAILYREVIEW program is a software application that is likely to benefit implementing school districts. For example, disruptive student behavior, which diverts teachers from instructional activities and has been linked to increased stress and poor morale, can be reduced with an implementation of the DAILYREVIEW program. A reduction in disruptive student behavior, is therefore, likely to benefit the district by creating rewarding classroom environments where teachers are able to spend more time on instruction and less time managing disruptive behavior.

The DAILYREVIEW program guides teachers through the process of developing a behavioral intervention that is consistent with the IDEA regulations. The DAILYREVIEW program facilitates compliance with IDEA and provides necessary documentation in case of litigation. Additionally, the DAILYREVIEW program leads to the development of an intervention that is individualized, empirically supported, and emphasizes parental involvement.

Recent educational initiatives call for restructuring of education systems and practices to more effectively serve children and youth with disabilities and other special needs in inclusive general education programs. Teachers, however, frequency voice concerns that they are not adequately prepared to cope with students with special needs. The DAILYREVIEW program is a web-based software solution that is capable of providing specific instruction and support, for regular and special education teachers, during the process of development and implementation of the district's behavioral management system and individualized behavioral plan for students who exhibit disruptive behaviors.

Traditionally, the implementation of behavioral interventions and management systems result in multiple paper trails that are difficult to monitor and manage. The DAILYREVIEW program uses standardized reporting forms that can be easily printed and stored with the student's academic records. As an additional feature, the software program maintains all student behavioral plans on a secured centralized database, which makes it easy for administrators to access and review student behavioral data.

The DAILYREVIEW program has been designed to help teachers work smarter, by reducing the amount of time managing disruptive student behavior and developing and implementing behavioral interventions and management systems for their classrooms. The use of a web-based platform translates into minimal IT demands for school district's technology departments. In addition, teachers are likely to require less training due to increased familiarity with an Internet based interface. Use of a web platform also allows teachers access to the most current version of the program.

School districts can use the DAILYREVIEW program to implement a contingency management behavioral system in which students accumulate points for positive behaviors or possibly lose points for negative behaviors. For meeting specific point goals students are rewarded on a daily and/or weekly basis. Dependent upon the district's behavioral management philosophy, students may progress through a set level system which has a fixed number of levels (e.g., 1, 2, 3, 4, etc.). Student's progress through the level system is dependent upon their demonstrated behavioral control. At each level students typically earn increasingly motivating sets of rewards and/or privileges. One can easily customize the program to convert districts' current behavioral management system into an on-line version and easily apply changes to the entire district. Supervisors are also able to do desktop monitoring of the classes to make sure that students are making adequate progress and that the district behavioral system is being implemented correctly. Supervisors set e-mail alerts when there are problems (e.g., a student is at a particular level too long or a teacher has not been implementing the system). Versions of the program may include an incident reporting feature. Teachers can easily report time out, restraint, and other high priority incidents. Dependent upon the district's configuration, the program automatically generates e-mails that are sent to campus administrators. Administrators are able to generate district, campus, teacher, or student specific reports. These reports provide data that are important in meeting state mandated requirements.

Aspects of one implementation of the present invention will be described in more detail with reference to the following example of a school district seeking to customize its application of the DAILYREVIEW program.

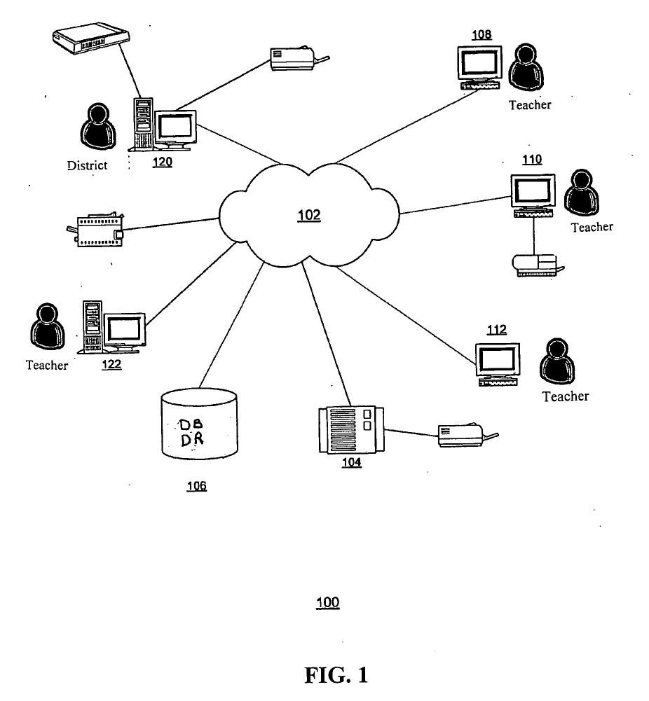

With reference now to the figures, and in particular with reference to FIG. 1, a pictorial representation of a distributed data processing system is depicted in which the program wizard of the present invention may be implemented.

The program wizard of the present invention is a tool that allows an entity, such as a school district, to efficiently customize a program, such as the DAILYREVIEW program. While the examples herein relate to the DAILYREVIEW program, the present invention is not limited to application with the DAILYREVIEW program.

The program wizard, in some embodiments, is designed to be platform independent, since many of the schools use Apple Macintosh as well as IBM clones. Thus, in some embodiments, the application will be designed to support both platforms as well as any other platforms desired.

Distributed data processing system 100 is a network of computers in which the worksheet wiz of the present invention may be implemented. Distributed data processing system 100 contains network 102, which is the medium used to provide communications links between various devices and computers connected within distributed data processing system 100. Network 102 may include permanent connections, such as wire or fiber optic cables, or temporary connections made through telephone connections.

Server 104 is connected to network 102, along with storage unit 106. Storage unit 106 is the repository for a program wizard of the present invention. In addition, clients 108, 110, 112, 120, and 122 are also connected to network 102. These clients, 108, 110, 112, 120, and 122 may be, for example, personal computers or network computers. For purposes of this application, a network computer is any computer coupled to a network that receives a program or other application from another computer coupled to the network.

In the depicted example, teachers or other school personnel utilize clients 110, 112, 120 and 122 to log into and use the DAILYREVIEW program. The DAILYREVIEW application may be stored and executed on clients 120 and 122 or may be provided by server 106, such as, for example, through the use of web pages provided to clients 120 and 122. The user may have to authenticate themselves to the program in order to verify that the person logging on has rights to do so.

In the depicted example, server 104 provides access to the program wizard to client 108. Clients 110, 112, 120, and 122 do not have access to the program wizard. Client 108 may be one or more of the program developer, school district personnel and third party programmer. Distributed data processing system 100 may include additional servers, clients, and other devices not shown. In alternative embodiments, the program wizard may be provided at a stand alone station, not otherwise connected to a network.

In the depicted example, distributed data processing system 100 is the Internet, with network 102 representing a worldwide collection of networks and gateways that use the TCP/IP suite of protocols to communicate with one another. Of course, distributed data processing system 100 also may be implemented as a number of different types of networks such as, for example, an intranet, a school's local area network (LAN), or a wide area network (WAN). Furthermore, in addition to passwords and user identifications, security measures, such as, for example, encryption and implementation of a virtual private network, may be utilized in order to protect the integrity of the system. FIG. 1 is intended as an example and not as an architectural limitation for the processes of the present invention.

Once the user is logged into the program wizard, the user is provided the opportunity to customize the DAILYREVIEW program. This program defines three different types of behavioral management systems that a school district may use in their behavioral classes, Cumulative Points, Good Days, and Individual systems. The Cumulative and Good Days systems both utilize levels. A Cumulative Points behavioral management system is designed so that a student's advancement from one level to another depends on a student earning a specific number of points. A Good Days behavioral management system is designed so that a student must exceed a daily point goal for a specific number of days. An Individual behavioral management system is designed so that a student must earn a specific number of points to meet a daily and/or weekly goal.

An implementation of the present invention provides efficient customization of rules of the behavioral management system and calculation of goals and progress criteria.

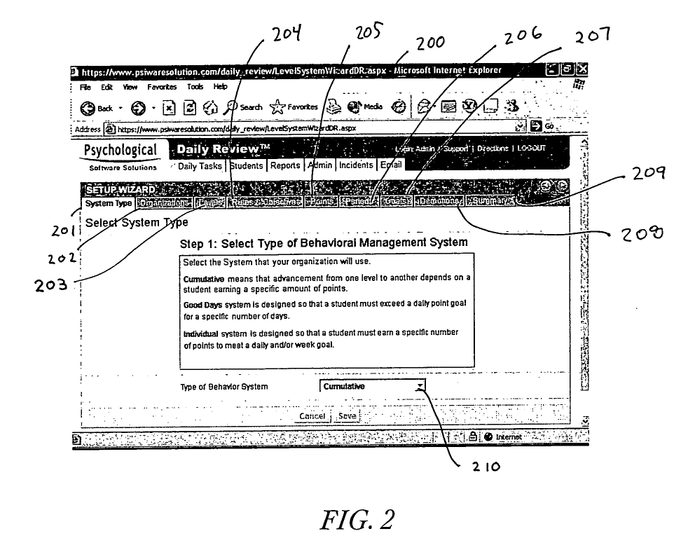

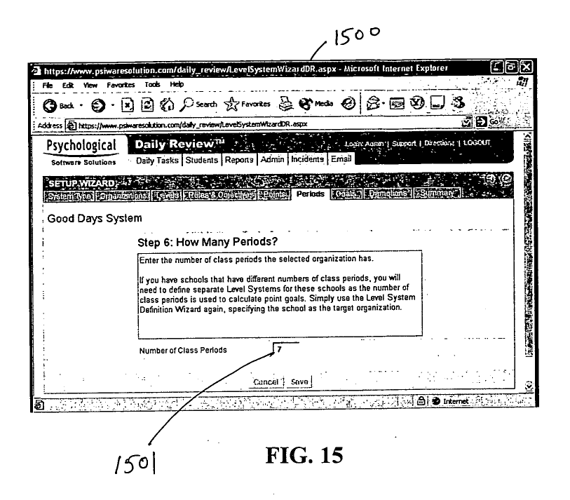

Turning now to FIGS. 2-25, exemplary user interfaces illustrating creation of a worksheet are depicted in accordance with one embodiment of the present invention. Users are able to access the program wizard from client machine 104. Initially, a login page (not shown) will be presented to the user allowing the user to enter a user name and password.

Once logged in, users will be presented with an interface 200 depicted in FIG. 2 allowing the user to choose what module they would like to access or action they would like to perform. For example, the user may selection choices 201-209. In this example, the nine choices 201-209 a user can select are 1) System Type, 2) Organizations, 3) Levels, 4) Rules & Objectives, 5) Points, 6) Periods, 7) Goals, 8) Demotions, and 9) Summary 502

Choice 201 of this module is to select the type of behavioral management system used in by the district, e.g., Cumulative Points, Good Days or Individual. In may also be practicable to include other types of behavioral management Systems which are known or later developed in other embodiments of the invention.

Cumulative Points System

If a user wishes to access a Cumulative behavioral management system, they would select “Cumulative” 210 from the screen 200 displayed in FIG. 2.

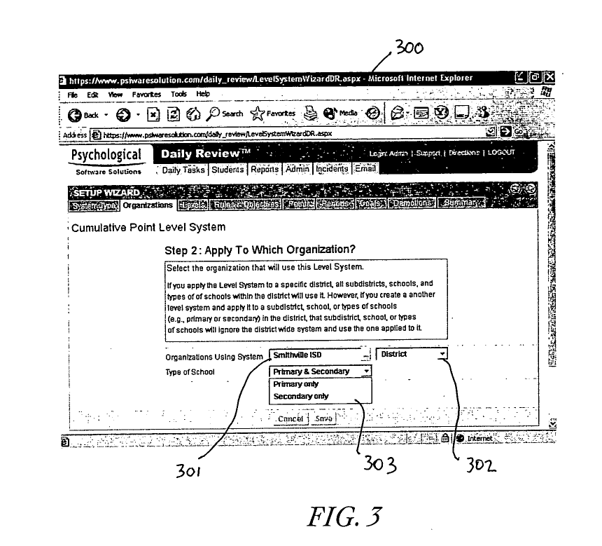

The next step in the example is illustrated in FIG. 3 and includes identifying the organization(s) to which the previously selected Behavioral System is to be applied. If the Behavioral System is applied to a specific district, all subdistricts, schools, and types of schools (e.g., primary and secondary) within the district may utilize the same Behavioral System. If another Behavioral System is defined and applied to a subdistrict, schools or types of schools, the higher Behavioral Systems may be ignored. In this manner, subdistricts, schools, or types of schools within a given district may have different Behavioral Systems than other subdistricts, schools, or types of schools within the district. In this example, the Cumulative Points Level System is applied to Smithville ISD 301, a district 302 and a Primary & Secondary school 303.

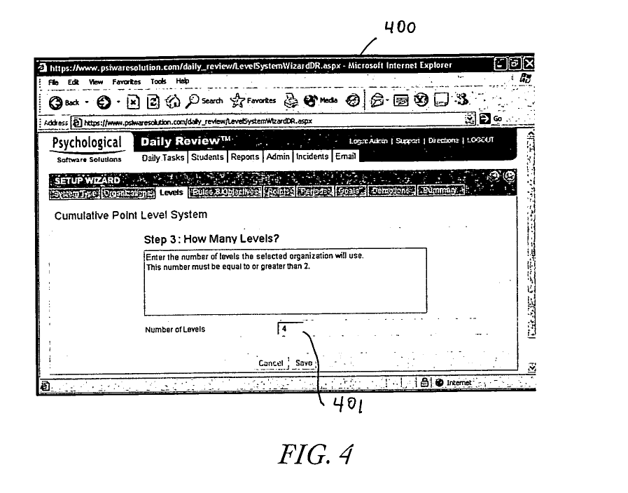

Screen 400 in FIG. 4 is where the user can enter the number of levels the selected organization will use. In this example, the district must use at least 2 levels. Typically, three to five levels are used. In alternative embodiments of the invention, different number of levels may be selected. The user in this example selected 4 levels, as depicted at 401.

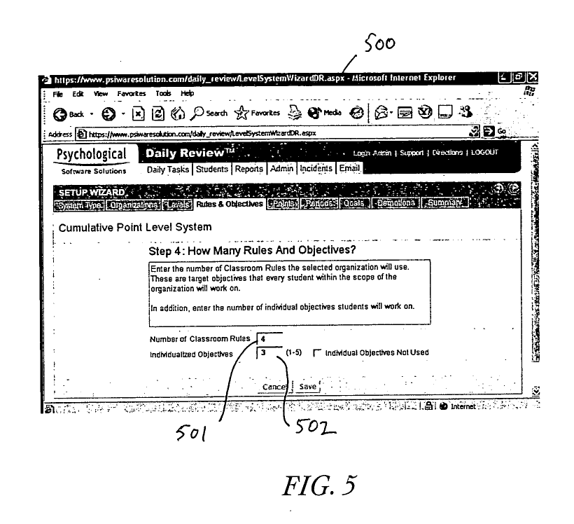

SCREEN 500 of FIG. 5 is where the user enters the number of classroom rules and individualized objectives the selected organization will use. Organizations have the option of using classroom rules 501 and/or individual objectives 502.

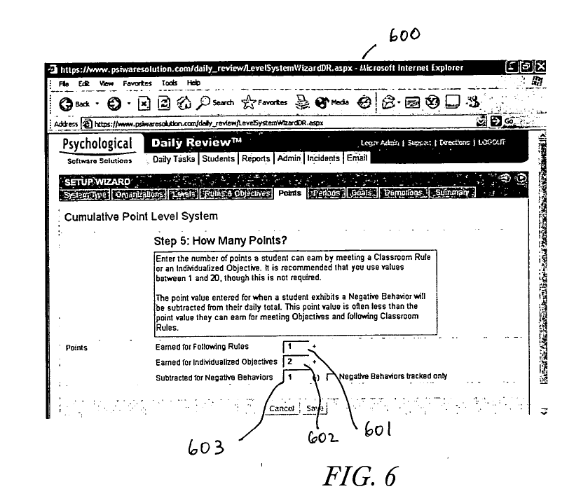

Screen 600 of FIG. 6 is where a user enters the number of points a student can earn by meeting a Classroom Rule or an Individualized Objective. Users may elect to use quarter, half, or third point increments. In alternative embodiments of the invention, a different point range or scale may be selected. The point total may be reduced by Negative Behavior. The point values associated with negative behavior may be less than the points assigned to positive behavior, e.g. meeting Objectives and following Classroom Rules. Users also have the option of not using negative points or having the teachers track the frequency of the behaviors without the frequency negatively impacting the student's point total. Points earned for following Classroom Rules are entered at 601. Points earned for Individualized Objectives are entered at 602 and points subtracted for Negative Behaviors are entered at 603.

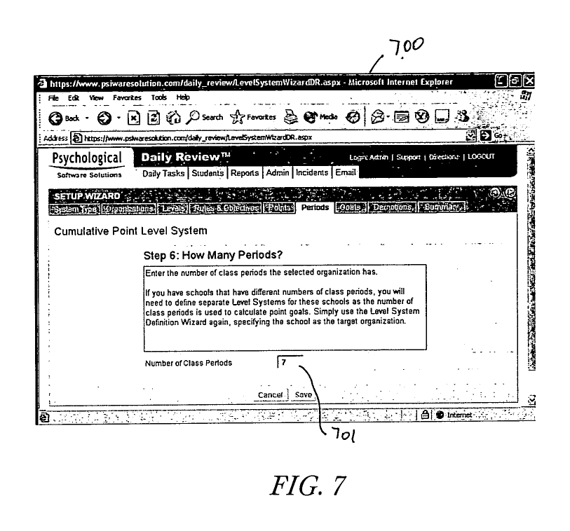

Screen 700 of FIG. 7 is where a user enters the number of Class Periods the selected organization has. If the organization has different numbers of Class Periods, separate Behavioral Systems can be defined. In this example, the user entered 7 as the number of Class Periods at 701.

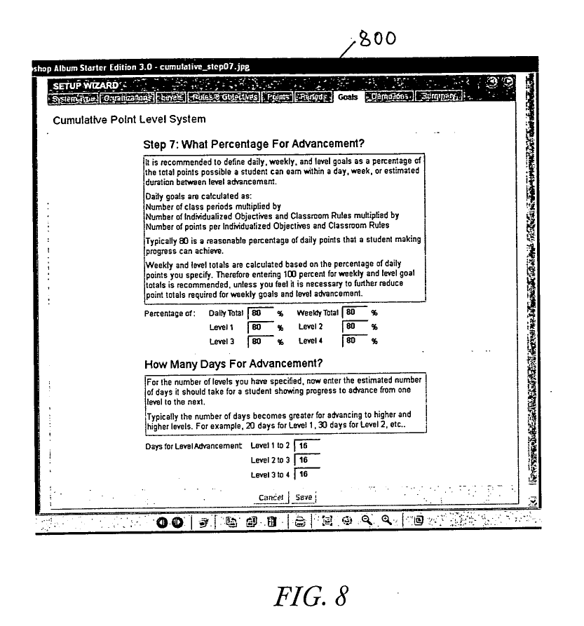

Screen 800 of FIG. 8 is where the user defines goals for advancement. It is recommended to define daily, weekly, and level goals as a percentage of the total points possible a student can earn. A variety of additional goals may be appropriate in another application of the present invention.

Daily Goals are calculated as:
Number of class periods multiplied by
Number of Individualized Objectives and Classroom Rules multiplied by
Number of points per Individualized Objectives and Classroom Rules.

The formula for calculating the weekly goal is the Daily Goal multiplied by 5.

The program wizard of the present invention allows for districts to define different percentages for each level of the behavioral system. The number of anticipated days to complete each level may vary by level and is determined by the user.

One criteria for progressing from level to level are calculated using the following formula:

Minimum Value for Level 1=0

Maximum Value for Level 1=((Daily Point Goal for the level)×(number of anticipated days for the level)−1).

Minimum Value for each subsequent level=(Daily Point Goal for the level)×(number of anticipated days for the level)+Minimum Value for the previous level.

Maximum Value for each subsequent level=Minimum Value for the current level+((Daily Point Goal for the level)×(number of anticipated days for the level)−1)

Minimum Value for the top level=(Daily Point Goal for the level)×(number of anticipated days for the level)+Minimum Value for the previous level.

Maximum Value for the top level is unlimited.

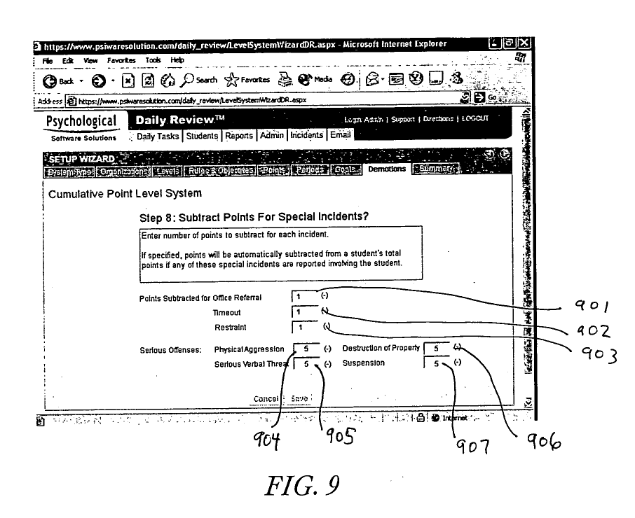

Screen 900 of FIG. 9 is where a user defines point total subtractions for special incidents. 901 is where a user enters points subtracted for an Office Referral. 902 is where the user enters points subtracted for a Timeout. 903 is where the user enters points subtracted for a Restraint. 904 is where a user enters the points subtracted for Physical Aggression. 905 is where the user enters the points subtracted for Serious Verbal Threat. 906 is where the user enters points subtracted for Destruction of Property and 907 is where the user enters points subtracted for Suspension. A variety of additional incidents may be appropriate in another application of the present invention.

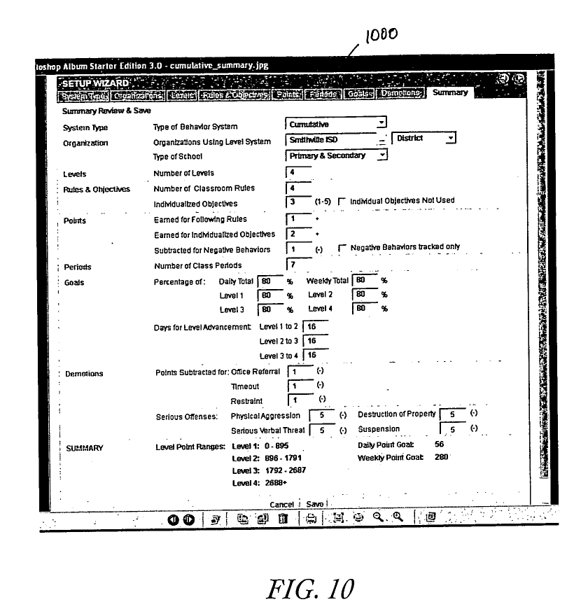

Screen 1000 of FIG. 10 is where a user can perform a System Review. Criteria for the behavioral system may be reviewed at this step. Updates to the system may be saved at this step or changes may be made to the previous definitions or determinations.

### Good Days Systems

If a user wishes to access a Good days behavioral management system, they would select “Good Days” at 210 from the screen 200 displayed in FIG. 2.

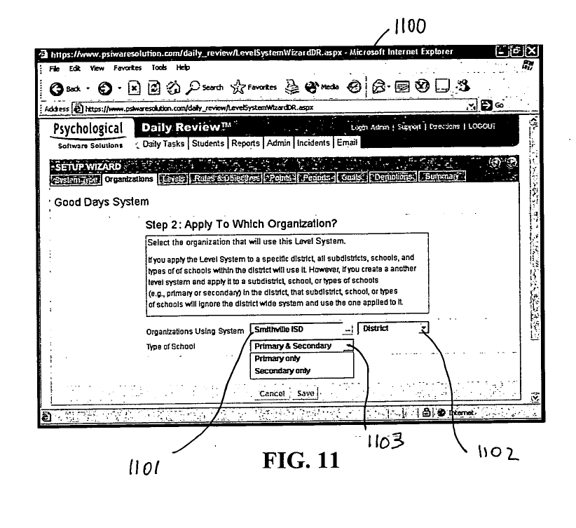

The next step in the example is illustrated in Screen 1100 of FIG. 11 and includes identifying the organization(s) to which the previously selected Behavioral System is to be applied. If the Behavioral System is applied to a specific district, all subdistricts, schools, and types of schools (e.g., primary and secondary) within the district may utilize the same Behavioral System. If another Behavioral System is defined and applied to a subdistrict, schools or types of schools, the higher Behavioral Systems may be ignored. In this manner, subdistricts, schools, or types of schools within a given district may have different Behavioral Systems than other subdistricts, schools, or types of schools within the district. In this example, the Cumulative Points Level System is applied to Smithville ISD 1101, a district 1102 and a Primary & Secondary school 1103.

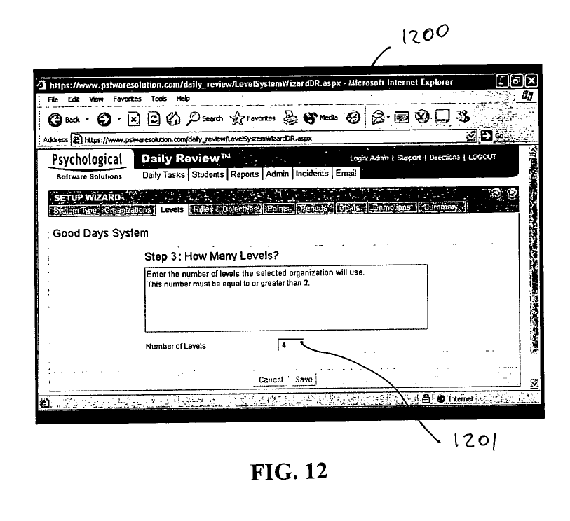

Screen 1200 in FIG. 12 is where the user can enter the number of levels the selected organization will use. In this example, the district must use at least 2 levels. Typically, three to five levels are used. In alternative embodiments of the invention, different number of levels may be selected. The user in this example selected 4 levels, as depicted at 1201.

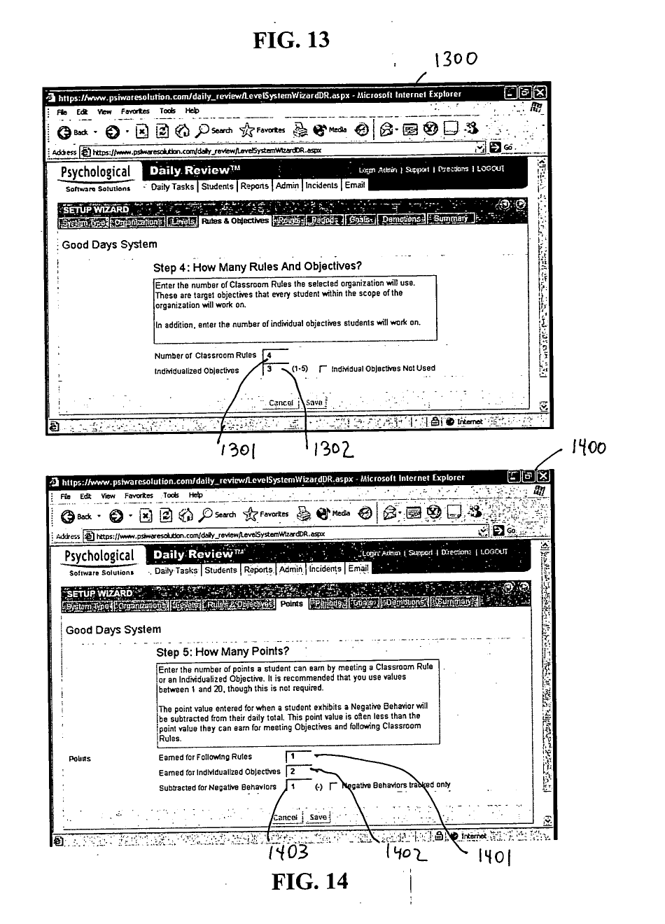

SCREEN 1300 of FIG. 13 is where the user enters the number of classroom rules and individualized objectives the selected organization will use. Organizations have the option of using classroom rules 1301 and/or individual objectives 1302.

Screen 1400 of FIG. 14 is where a user enters the number of points a student can earn by meeting a Classroom Rule or an Individualized Objective. Users may elect to use quarter, half, or third point increments. In alternative embodiments of the invention, a different point range or scale may be selected. The point total may be reduced by Negative Behavior. The point values associated with negative behavior may be less than the points assigned to positive behavior, e.g. meeting Objectives and following Classroom Rules. Users also have the option of not using negative points or having the teachers track the frequency of the behaviors without the frequency negatively impacting the student's point total. Points earned for following Classroom Rules are entered at 1401. Points earned for Individualized Objectives are entered at 1402 and points subtracted for Negative Behaviors are entered at 1403.

Screen 1500 of FIG. 5 is where a user enters the number of Class Periods the selected organization has. If the organization has different numbers of Class Periods, separate Behavioral Systems can be defined. In this example, the user entered 7 as the number of Class Periods at 1501.

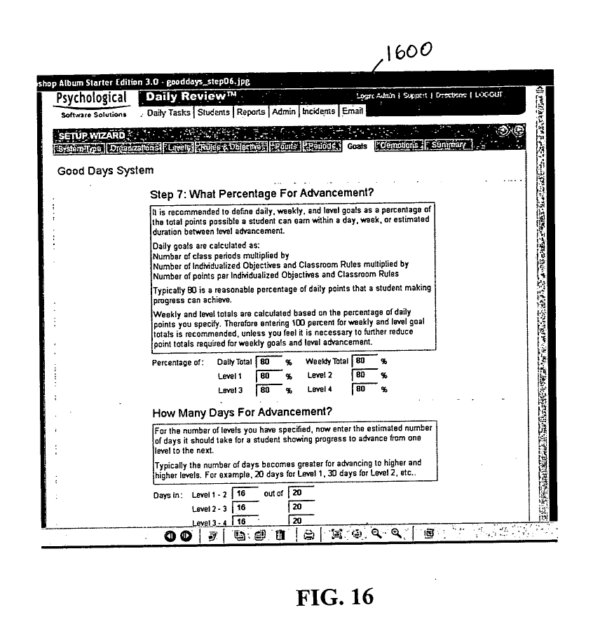

Screen 1600 of FIG. 16 is where the user defines goals for advancement. It is recommended to define daily, weekly, and level goals as a percentage of the total points possible a student can earn. A variety of additional goals may be appropriate in another application of the present invention.

Daily Goals are calculated as:
Number of class periods multiplied by
Number of Individualized Objectives and Classroom Rules multiplied by
Number of points per Individualized Objectives and Classroom Rules.

The formula for calculating the weekly goal is the Daily Goal multiplied by 5.

System includes the ability to have different percentages for each level.

The criteria for progressing from level to level are not calculated rather the district enters the number of days out of a specified time period that a student must meet his or her daily goal. In the below example, the student must meet his or her daily goals 16 out of the past 20 days in order to be promoted from the current level to the subsequent level. Both the number of “Good Days” and specified time period may vary by level. Once the student is at the top level the student's progress is evaluated based on the percent of time he or she is meeting their daily goal.

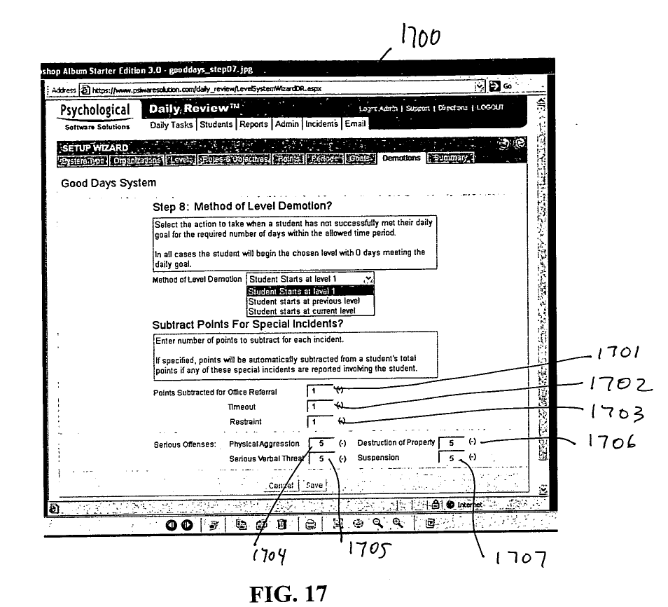

Screen 1700 of FIG. 17 includes the methodology used by the district to demote the student's level in situations where the student has failed to meet his or her daily goal for the required number of days within the allowed time period. For example, if the student does not meet his or her daily goal for the required period of time the district can choose to start them over at level 1, from the start of the previous level, or start over again at their current level. A variety of additional methods may be appropriate in another application of the present invention.

In this screen, users also define point total subtractions for special incidents. 1701 is where a user enters points subtracted for an Office Referral. 1702 is where the user enters points subtracted for a Timeout. 1703 is where the user enters points subtracted for a Restraint. 1704 is where a user enters the points subtracted for Physical Aggression. 1705 is where the user enters the points subtracted for Serious Verbal Threat. 1706 is where the user enters points subtracted for Destruction of Property and 1707 is where the user enters points subtracted for Suspension. A variety of additional incidents may be appropriate in another application of the present invention.

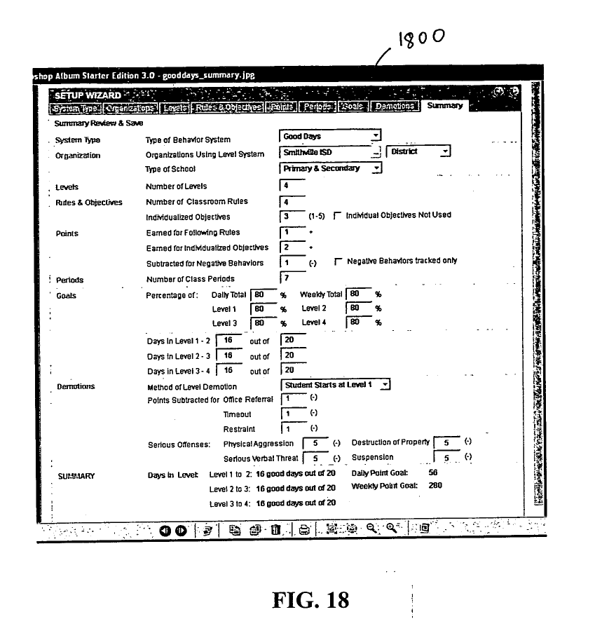

Screen 1800 of FIG. 18 is where a user can perform a System Review. Criteria for the behavioral system may be reviewed at this step. Updates to the system may be saved at this step or changes may be made to the previous definitions or determinations.

### INDIVIDUAL SYSTEM

If a user wishes to access a Good days behavioral management system, they would select “Individual” at 210 from the screen 200 displayed in FIG. 2.

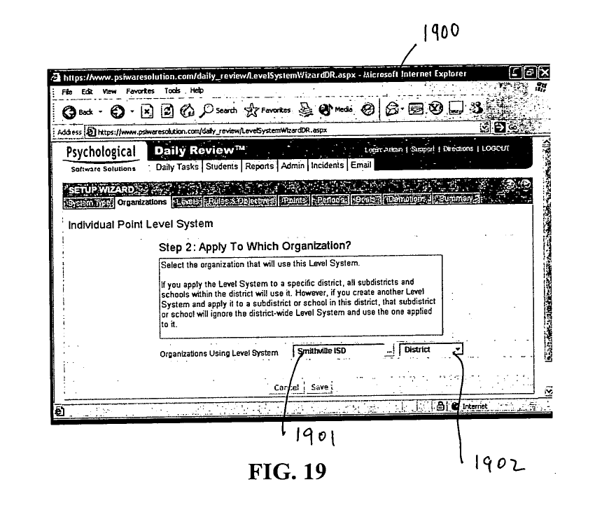

The next step in the example is illustrated in Screen 1900 of FIG. 19 and includes identifying the organization(s) to which the previously selected Behavioral System is to be applied. If the Behavioral System is applied to a specific district, all subdistricts, schools, and types of schools (e.g., primary and secondary) within the district may utilize the same Behavioral System. If another Behavioral System is defined and applied to a subdistrict, schools or types of schools, the higher Behavioral Systems may be ignored. In this manner, subdistricts, schools, or types of schools within a given district may have different Behavioral Systems than other subdistricts, schools, or types of schools within the district. In this example, the Individual Point Level System is applied to Smithville ISD 1901 and district 1902.

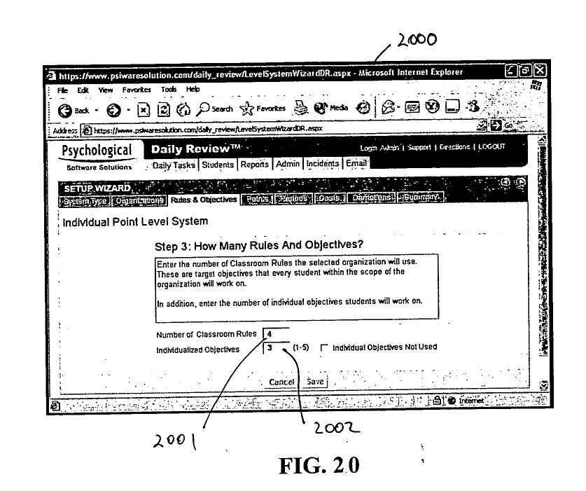

SCREEN 2000 of FIG. 20 is where the user enters the number of classroom rules and individualized objectives the selected organization will use. Organizations have the option of using classroom rules 2001 and/or individual objectives 2002.

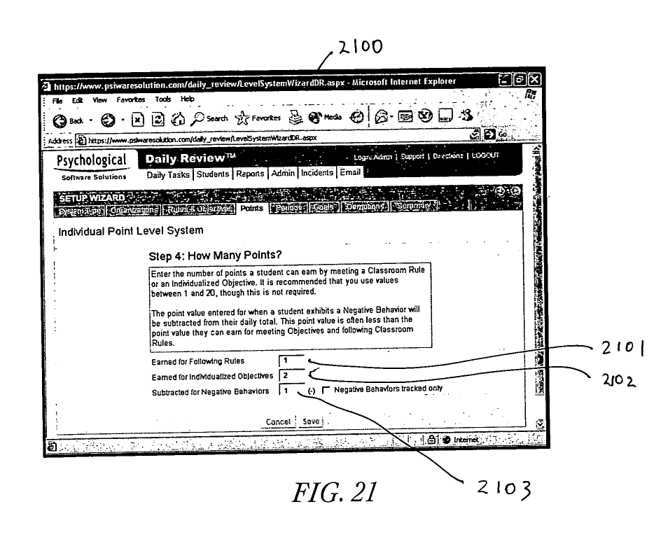

Screen 2100 of FIG. 21 is where a user enters the number of points a student can earn by meeting a Classroom Rule or an Individualized Objective. Users may elect to use quarter, half, or third point increments. In alternative embodiments of the invention, a different point range or scale may be selected. The point total may be reduced by Negative Behavior. The point values associated with negative behavior may be less than the points assigned to positive behavior, e.g. meeting Objectives and following Classroom Rules. Users also have the option of not using negative points or having the teachers track the frequency of the behaviors without the frequency negatively impacting the student's point total. Points earned for following Classroom Rules are entered at 2101. Points earned for Individualized Objectives are entered at 2102 and points subtracted for Negative Behaviors are entered at 2103.

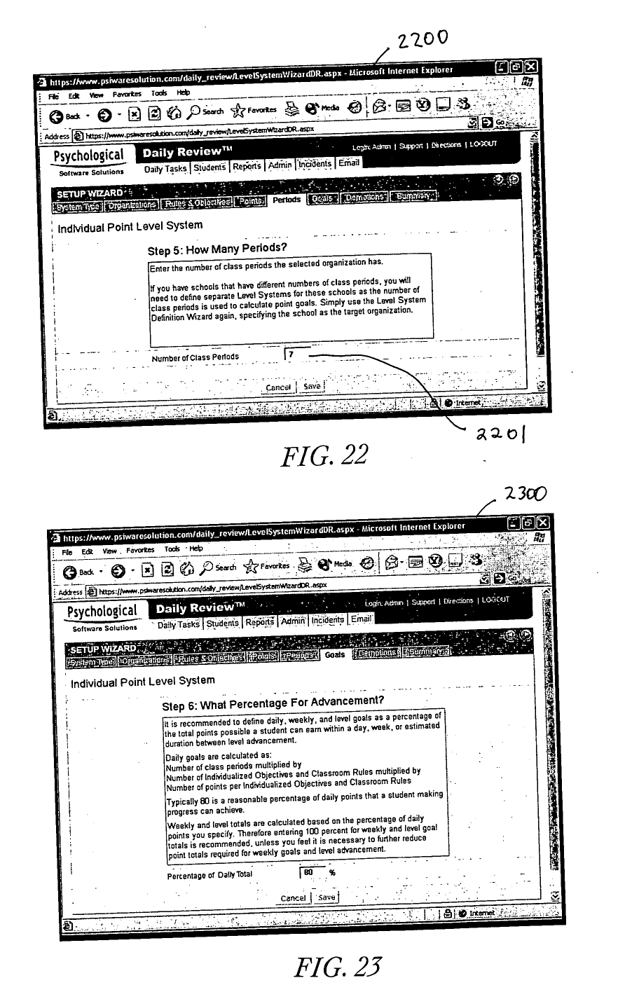

Screen 2200 of FIG. 22 is where a user enters the number of Class Periods the selected organization has. If the organization has different numbers of Class Periods, separate Behavioral Systems can be defined. In this example, the user entered 7 as the number of Class Periods at 2201.

Screen 2300 of FIG. 23 is where the user defines goals for advancement It is recommended to define daily goals as a percentage of the total points possible a student can earn. A variety of additional goals may be appropriate in another application of the present invention. Daily goals are calculated as:
Number of class periods multiplied by
Number of Individualized Objectives and Classroom Rules multiplied by
Number of points per Individualized Objectives and Classroom Rules.

The formula for calculating the weekly goal is the Daily Goal multiplied by 5.

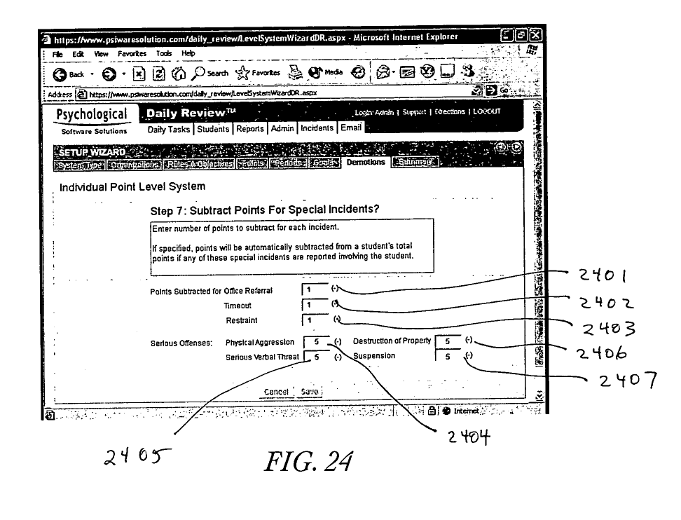

Screen 24 of FIG. 24 includes the methodology used by the district to demote the student's level in situations where special incidents are present. 2401 is where a user enters points subtracted for an Office Referral. 2402 is where the user enters points subtracted for a Timeout. 2403 is where the user enters points subtracted for a Restraint. 2404 is where a user enters the points subtracted for Physical Aggression. 2405 is where the user enters the points subtracted for Serious Verbal Threat. 2406 is where the user enters points subtracted for Destruction of Property and 2407 is where the user enters points subtracted for Suspension. A variety of additional incidents may be appropriate in another application of the present invention.

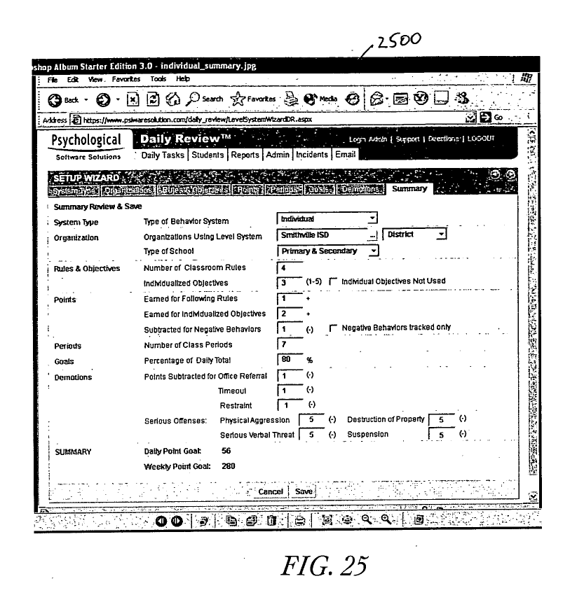

Screen 2500 of FIG. 25 is where a user can perform a System Review. Criteria for the behavioral system may be reviewed at this step. Updates to the system may be saved at this step or changes may be made to the previous definitions or determinations.

In addition to the services and functionality described above, the program wizard could include additional enhancements. It is important to note that while the present invention has been described in the context of a fully functioning data processing system, those of ordinary skill in the art will appreciate that the processes of the present invention are capable of being distributed in the form of a computer readable medium of instructions and a variety of forms and that the present invention applies equally regardless of the particular type of signal bearing media actually used to carry out the distribution

Although the present invention and its advantages have been described in detail, it should be understood that various changes, substitutions and alterations can be made herein without departing from the spirit and scope of the invention as defined by the appended claims. Moreover, the scope of the present application is not intended to be limited to the particular embodiments of the process, machine, manufacture, composition of matter, means, methods and steps described in the specification. As one of ordinary skill in the art will readily appreciate from the disclosure of the present invention, processes, machines, manufacture, compositions of matter, means, methods, or steps, presently existing or later to be developed that perform substantially the same function or achieve substantially the same result as the corresponding embodiments described herein may be utilized according to the present invention. Accordingly, the appended claims are intended to include within their scope such processes, machines, manufacture, compositions of matter, means, methods, or steps.

What is claimed is:

1. A method for providing interactive assistance with customizing an automated program comprising:
identifying a software solution for implementing the automated program;
selecting a behavioral management system;
defining parameters of said behavioral management system;
defining rule-based features of implementation of said behavioral system; and
customizing said software solution based on said defining parameters and rule-based features of implementation.

2. The method of claim 1 wherein said customizing modifies a software solution that is capable of providing specific instruction and support, for regular and special education teachers, during a process of development and implementation of a district's behavioral management system or individualized behavioral plan for students who exhibit disruptive behavior.

3. The method of claim 2 at least partially performed within a web-based platform.

4. A system for processing input data to generate output data comprising:
an input module operable for accepting input from a user;
a processing module; and
an output module operable for outputting output data to a user,
wherein said output data comprises data relating to a behavioral management system with defined rule-based features of implementation, and
wherein said behavioral management system is customized by said processing module based on said user input.

5. The system of claim 4 wherein said behavioral management system includes defined parameters, and said behavioral management system is customized by said parameters.

6. The system of claim 4 wherein said customizing modifies a software solution that is capable of providing specific instruction and support, for regular and special education teachers, during a process of development and implementation of a district's behavioral management system or individualized behavioral plan for students who exhibit disruptive behavior.

7. The system of claim 6 wherein said output data comprises a representation of performance of a student.

8. The system of claim 4 wherein said input comprises selection of a behavioral management system.

9. The system of claim 8 wherein said behavioral management system is selected from the group consisting of Cumulative, Good Days and Individual.

10. The system of claim 8 wherein said input comprises selection of an organization that the output data will be applied to.

11. The system of claim 10 wherein said organization is a school district.

12. The system of claim 8 wherein said input comprises selection of a level.

13. The system of claim 8 wherein said input comprises a designation of classroom rules to be used.

14. The system of claim 8 wherein said input comprises a designation of individual objectives students will work on.

15. The system of claim 7 wherein said input comprises a definition of point assignments.

16. The system of claim 15 wherein said point assignments include the number of points a student can earn for meeting a classroom rule or an individualized objective.

17. The system of claim 15 wherein said point assignments include a subtraction of points based on negative student behavior.

18. The system of claim 8 wherein said input comprises a definition of goals for advancement by a student.

19. The system of claim 18 wherein said goals include daily, weekly and level goals.

20. The system of claim 18 wherein a daily goal is calculated as a number of class periods multiplied by a number of individualized objectives and classroom rules multiplied by a number of points per individualized objectives and classroom rules.

21. The system of claim 18 wherein said weekly and level goals are calculated based on a percentage of daily points specified by said input.

22. The system of claim 8 wherein said input comprises a number of days for a student to advance from one level to the next level.

23. The system of claim 8 wherein said input comprises a definition of points to be subtracted based on a special incident.

24. The system of claim 23 wherein said special incident is an event selected from the group consisting of office referral, timeout, restraint, physical aggression, destruction of property, suspension and verbal threat.

25. The system of claim 4 wherein said behavioral management system is customized after an opportunity of said user to review said input:
